(19) United States
(12) Patent Application Publication
(10) Pub. No.: US 2007/0238046 A1
(43) Pub. Date: Oct. 11, 2007

(54) Laser marking

(75) Inventor: Lee Sutter, Irvine, CA (US)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: THE DOMINO CORPORATION

(21) Appl. No.: 11/399,591

(22) Filed: Apr. 7, 2006

(51) Int. Cl. G03C 1/00

(52) U.S. Cl. 430/270.1

(57) ABSTRACT

Individually generated laser beams are combined to provide a composite, co-focal output. Such beams, which are of two different wavelengths, are particularly suitable for laser marking applications. A particular embodiment is described which is useful for marking thermo-chromic materials overlaid with plastics comprising or containing polypropylene.

### FIELD OF THE INVENTION

This invention relates to laser marking and specifically, though not necessarily solely, to laser marking and/or coding of packaging materials using CO₂ lasers.

### BACKGROUND OF THE INVENTION

Lasers have been used for some time to mark and/or code materials used to package consumer goods. However it has long been recognised that the response of certain materials to laser beams is closely correlated to the laser wavelength. See for example, U.S. Pat. No. 5,010,231. This means that a given laser marking apparatus will not optimally mark all typical substrates such as PET bottles, colour coated paper and plastics labels, and polypropylene over-coated labels and boxes.

The method described in U.S. Pat. No. 5,010,231 addresses material differences by using a wavelength tuneable CO₂ laser whose output wavelength is tuneable. This may be suitable for the particular application described in the patent, which is forming lines of weakness in packaging materials. Such an application typically involves processing long runs of material of one composition. However, marking and coding applications present their own particular problems in that items of different material composition may need to be marked sequentially and/or the marking and coding equipment may need to be switched rapidly to different applications, making the use of tuneable lasers impractical.

It is an object of this invention to provide laser marking methods and apparatus which will go at least some way in addressing aforementioned problems; or which will at least provide a novel and useful choice.

### SUMMARY OF THE INVENTION

Accordingly, in one aspect, the invention provides laser marking apparatus configured to emit two laser beams, said apparatus being characterised in that the beams are of different wavelengths and are emitted co-linearly.

Preferably said two laser beams are arranged to be substantially co-focal on a target substrate.

Preferably said laser beams are generated as parallel beams, one of said beams being deflected by an optical arrangement into a co-axial relationship with the other.

Alternatively said optical arrangement is configured to deflect one of said beams into a nested, parallel relationship with the other beam.

Preferably said two beams are generated using CO₂ lasers.

Preferably one of said two beams has a wavelength of 10.2 to 10.4 microns and the other of said two beams has a wavelength of 9.15 to 9.35 microns.

Alternatively one of said two beams has a wavelength of 10.5 to 10.7 microns and the other of said two beams has a wavelength of 9.15 to 9.35 microns.

In a further alternative one of said beams is generated by a solid state YAG laser configured to emit a laser of wavelength 1.06 microns whilst the other of said two beams is a CO₂ laser of any wavelength.

In a second aspect the invention provides a method of marking a substrate having at least two layers, said method including the step of exposing said substrate to two co-linear laser beams, said beams being of different wavelengths.

Preferably said two laser beams are arranged to be substantially co-focal on said substrate.

Preferably said beams are arranged to converge on said substrate co-axially.

Alternatively said beams are arranged in a nested parallel arrangement to converge on said substrate.

Preferably said substrate includes an outer layer comprising or containing polypropylene, said method including exposing said substrate to a first laser source having a wavelength of 10.5 to 10.7 microns and to a second laser source having a wavelength of 9.15 to 9.35 microns.

Alternatively said method includes exposing said substrate to a first laser source having a wavelength of 10.2 to 10.4 microns and to a second laser source having a wavelength of 9.15 to 9.35 microns.

In a third aspect the invention provides a method of marking a substrate, said substrate having an outer layer of plastics material substantially transparent to laser energy and a layer of laser markable material there-below, said method including subjecting said substrate simultaneously to two laser beams of different wavelengths, one of said wavelengths being selected to condition said laser markable material and the other of said beams being selected to effect marking of said laser markable material.

Preferably said method is applied to the marking of thermochromic materials overlaid with a material comprising or containing polypropylene.

In a fourth aspect the invention provides a method of marking a substrate, said substrate having an outer layer of plastics material substantially transparent to laser energy and a layer of laser markable material there-below, said method including subjecting said substrate simultaneously to two substantially co-focal laser beams of different wavelengths, said two wavelengths being selected to condition and mark said laser markable material without ablating said outer layer.

Preferably said method is applied to the marking of thermochromic materials overlaid with a material comprising or containing polypropylene.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

The various aspects of the invention will now be described with reference to the accompanying drawings in which:

FIG. 1: shows an isometric view of one form of laser marking device according to the invention;

FIG. 2: shows an alternative form of laser marking device according to the invention;

FIG. 3: shows a further alternative form of laser marking device according to the invention; and

FIG. 4: shows an enlarged cross section through a multi-layer substrate when marked and/or coded by apparatus according to the invention.

### DETAILED DESCRIPTION OF WORKING EMBODIMENT

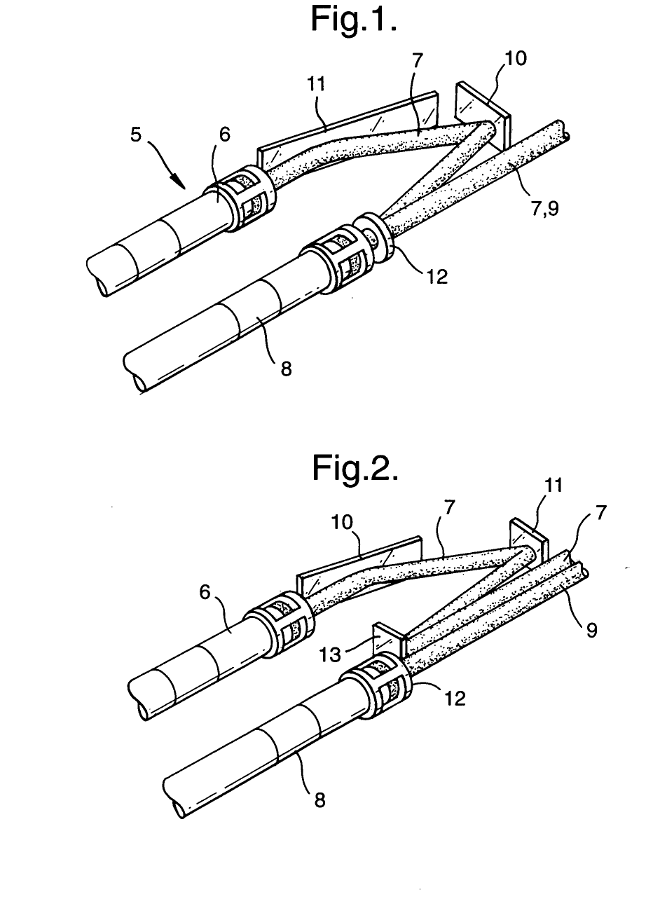

Referring to FIG. 1, a first form of laser marking device 5 is provided having the characteristic features of the invention. As shown, the device 5 includes a first laser generator 6 and a second laser generator 8. As can be seen, the generators 6 and 8 are arranged side-by-side and emit randomly polarized laser beams 7 and 9 respectively.

In accordance with the invention the beams 7 and 9 are of different wavelengths and are combined in a substantially co-linear relationship so that they have a common or substantially common focal point on the substrate to be marked. In this way, a variety of packaging materials of differing compositions can be more effectively marked with no changes or adjustment being necessary to the marking and coding equipment.

In the embodiment shown in FIG. 1, beam 7 is deflected by mirrors 10 and 11 back to the exit mirror 12 of the laser generator 8. There the beam is combined co-axially with the beam 9. The precise form of the mirrors will be known to those skilled in the art and the angles thereof are selected to ensure the beam 7 falls on the mirror 12 at the proper angle of incidence. The mirrors may be coated to enhance the wavelength reflected from a particular mirror at its given angle.

In the embodiment shown in FIG. 2, the beam 7 is deflected by mirrors 10 and 11 back to a further mirror 13 positioned adjacent the exit mirror 12 of the laser generator 12. In this way the beams 7 and 9 are positioned adjacent, parallel and nested with one another and, effectively, are focussed on the same position on the target substrate. In this embodiment the beams 7 and 9 are preferably directly adjacent, though spacing is not critical. If the beams are spaced apart then depth of field is compromised, while if the beams partially overlap, some beam clipping will occur. The important point is that the beams are substantially co-focal on the substrate.

For general package marking and coding applications, the laser generator 6 is preferably a CO₂ laser configured to generate a beam 7 of 10.2 to 10.4 microns wavelength. The laser generator 8 is preferably also a CO₂ laser configured to generate a beam 9 of 9.15 to 9.35 microns. We have found that this combination provides a substantially optimum solution for marking and coding PET bottles, colour coated paper and plastics labels.

At present there is a particular requirement for apparatus to mark and code laser markable thermo-chromic materials over-coated with a layer of transparent plastics film, most commonly film comprising or containing substantial amounts of polypropylene. Existing laser marking and coding equipment is unable to effectively mark and code such substrates. We have found that, by using a suitable configured embodiment of the present invention an extremely effective outcome results. More surprisingly, we have found that we are able to effect marking of the thermo-chromic layer whilst keeping the plastics covering layer intact.

Referring now to FIG. 4, a substrate 15 is shown comprising a layer 16 of thermo-chromic material over-coated with a layer 17 of plastics comprising or containing polypropylene. The beams 7 and 9 are selected to pass through the layer 17 with little absorption thereof, but combine to form highly visible marking on the layer 16. We have found that, by combining beams of wavelengths 10.5 to 10.7 microns and 9.15 to 9.35 microns, effective marking results without any ablation of the layer 17. It is believed that the longer wavelength beam effects marking whilst the shorter wavelength beam conditions or assists by raising the substrate temperature whilst not affecting/damaging the polypropylene layer.

Whilst the embodiments described above employ two CO₂ lasers, it is envisaged that the present invention could also employ a solid-state YAG laser emitting a beam in the range 1.00 to 1.20 microns, in combination with any of the possible laser wavelengths capable of being produced by the carbon dioxide molecule for all the known isotopic combinations of carbon and oxygen. These are identified in a paper by Freed et al; IEEE Journal of Quantum Electronics, Vol. QE-16, No. 11, November 1980.

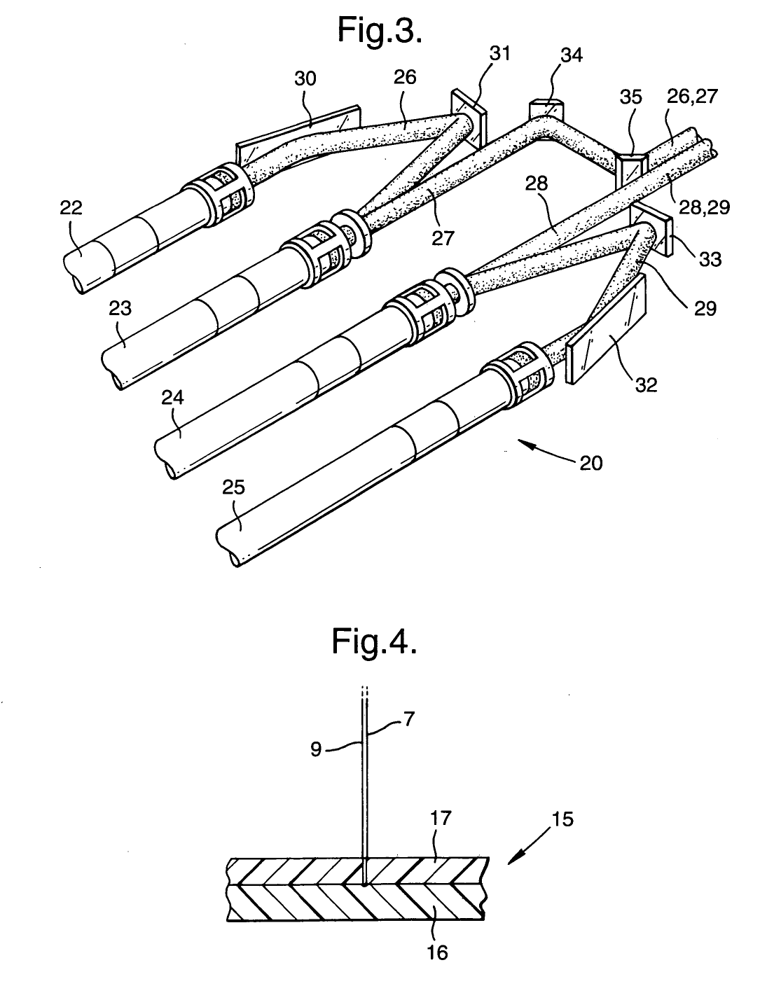

Turning now to FIG. 3, a further embodiment 20 of laser marking device is provided, which combines aspects of the devices shown in FIGS. 1 and 2. As shown, the device 20 has four separate laser generating tubes 22, 23, 24 and 25 which, respectively, generate beams 26, 27, 28 and 29. In the same manner as described with reference to FIG. 1, beam 26 is combined co-axially with beam 27 using mirrors 30 and 31, whilst beam 29 is combined co-axially with beam 28 by mirrors 32 and 33. Composite beam 26,27 is then deflected by mirrors 34 and 35 into co-linear and substantially co-focal relationship with composite beam 28,29.

The tubes 22, 23, 24 and 25 may be CO₂ lasers generating wavelengths as described above, or may be combinations of CO₂ and YAG lasers. It is envisaged that configurations such as that shown in FIG. 3 will be used in those applications in which processing speed is high and there is a greater need to more quickly condition the substrate to be marked.

1. Laser marking apparatus configured to emit two laser beams, said apparatus being characterised in that the beams are of different wavelengths and are emitted co-linearly.

2. Apparatus as claimed in claim 1 wherein said laser beams are generated as parallel beams, one of said beams being deflected by an optical arrangement into a co-axial relationship with the other.

3. Apparatus as claimed in claim 1 further including an optical arrangement configured to deflect one of said beams into a nested, parallel relationship with the other beam.

4. Apparatus as claimed in any one of claim 1 wherein said two beams are generated using CO₂ lasers.

5. Apparatus as claimed in claim 4 wherein one of said two beams has a wavelength of 10.2 to 10.4 microns and the other of said two beams has a wavelength of 9.15 to 9.35 microns.

6. Apparatus as claimed in claim 4 wherein one of said two beams has a wavelength of 10.5 to 10.7 microns and the other of said two beams has wavelength of 9.15 to 9.35 microns.

7. Apparatus as claimed in claim 1 wherein one of said beams is generated by a solid state YAG laser configured to emit a laser of wavelength 1.06 microns whilst the other of said two beams is a CO₂ laser of any wavelength.

8. A method of marking a substrate having at least two layers, said method including the step of exposing said substrate to two co-linear laser beams, said beams being of different wavelengths.

9. A method as claimed in claim 9 including arranging said beams to converge on said substrate co-axially.

10. A method as claimed in claim 8 including arranging said beams in a nested parallel arrangement to converge on said substrate.

11. A method as claimed in claim 8 wherein said substrate includes an outer layer comprising or containing polypropylene, and wherein said method includes exposing said substrate to a first laser source having a wavelength of 10.5 to 10.7 microns and to a second laser source having a wavelength of 9.15 to 9.35 microns.

12. A method as claimed in claim 8 wherein said method includes exposing said substrate to a first laser source having a wavelength of 10.2 to 10.4 microns and to a second laser source having a wavelength of 9.15 to 9.35 microns.

13. A method of marking a substrate, said substrate having an outer layer of plastics material substantially transparent to laser energy and a layer of laser markable material there-below, said method including subjecting said substrate simultaneously to two laser beams of different wavelengths, one of said wavelengths being selected to condition said laser markable material and the other of said beams being selected to effect marking of said laser markable material.

14. A method of marking a substrate, said substrate having an outer layer of plastics material substantially transparent to laser energy and a layer of laser markable material there-below, said method including subjecting said substrate simultaneously to two laser beams of different wavelengths, one of said wavelengths being selected to condition said laser markable material and the other of said beams being selected to effect marking of said laser markable material.

15. A method as claimed in claim 13 when applied to the marking of thermochromic materials overlaid with a material comprising or containing polypropylene.
